(19) United States
(12) Patent Application Publication
(10) Pub. No.: US 2006/0280189 A1
(43) Pub. Date: Dec. 14, 2006

(54) Residential gateway discovery

(76) Inventors: Matthew McRae, Laguna Beach, CA (US); Kendra S. Harrington, Irvine, CA (US); Allen J. Huotari, Garden Grove, CA (US); Manrique Brenes, Corona Del Mar, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/152,312

(22) Filed: Jun. 13, 2005

(51) Int. Cl. H04L 12/28

(52) U.S. Cl. 370/401

(57) ABSTRACT

A method and system facilitates enhanced communication between a LAN and a WAN by determining which IP device of the LAN is a gateway and then restricting communication between the LAN and the WAN such that the communication is routed through the gateway. Determining which IP device of the LAN is a gateway can comprise using DHCP protocol to implement a provisioning and setup flow between a WAN bridge and gateway. By restricting communication between the LAN and the WAN such that it is routed through the gateway, features of the gateway such as a firewall and/or parental controls, can be advantageously utilized.

### TECHNICAL FIELD

The present invention relates generally to computer networking. The present invention relates more particularly to a method and system for insuring that communications between a local area network (LAN) and a wide area network (WAN) are routed through a gateway.

### BACKGROUND

Internet service is almost ubiquitous. Service providers are deploying increasingly more advanced broadband services to their subscribers. The subscribers are attaching a growing number of Internet Protocol (IP) devices to their home and business networks. For example, not only are computers being attached to such networks, but televisions and telephones are also routinely attached.

Shared physical mediums have been developed, at least partially as a result of the desire to connect such devices to a network. Several of the home and business networking topologies currently in use and under future consideration use a shared medium for both WAN and LAN connectivity, thus reducing cost and complexity of the devices attached thereto. The use of a shared medium may occur, for example, when a bridge is used to facilitate communication between a service provider and a LAN. Wireless access (such as WiFi), Multimedia over Coax Alliance (MoCA), and HomePlug are examples of shared media.

However, when the WAN and LAN ports share the same physical medium in a home or business network, traffic originating from devices on the LAN that is destined for the WAN is not physically forced to be routed through the gateway. Similarly, traffic originating from a WAN that is destined for the LAN is not physically forced to be routed through the gateway. Thus, the gateway is not necessarily a physically intermediate device between the LAN and the WAN. This means that devices on a home or business network may not be protected by the features provided by the gateway, such as the firewall and parental controls.

Furthermore, an IP device on the home or business network could inadvertently receive an IP address from a dynamic host configuration protocol (DHCP) server on the WAN instead of from the LAN's gateway. Thus, although the use of a shared physical medium has proven generally suitable for its intended purpose, such configuration does present inherent deficiencies which detract from its overall effectiveness and desirability.

These problems can be alleviated by implementing manual medium access controller identification (MAC ID) filtering on the service provider's DHCP servers, but this procedure is labor intensive. Further, it does not readily allow a user to install new gateway devices. MAC ID filtering also presents a scaling problem and thus could have a significant cost impact on the service provider.

Therefore, it is desirable to provide a method and system to ensure that all LAN traffic originating from LAN IP devices is only routed through the gateway and that all WAN traffic originating from the broadband network (including the Internet) is only routed to the LAN via the gateway. In this manner, features of the gateway can be advantageously utilized.

This problem is becoming more urgent as service providers begin to deploy bridging devices using fiber-to-the-home (FTTH) and other broadband WAN technologies on the network access side. They connect these bridging devices to the gateway via a shared medium that may also be used for a home or business LAN. For instance, a fiber optical network terminal (ONT) may utilize MOCA or HomePlug to enter the house without having to install Ethernet cable (which may require the drilling of holes, etc.), while also providing connectivity between devices in the home or business network.

Routing through a gateway could be forced by using tunneling or 802.1x-like technologies in the gateway and service provider network, but these are not simple solutions. Furthermore, it cannot be assumed that these technologies exist in the gateway (such as a residential gateway purchased at retail). It is thus desirable to resolve this problem in a manner that does not conflict with existing gateways and routers or require technologies that typically do not reside in consumer based products.

### BRIEF DESCRIPTION OF THE DRAWINGS

FIG. 1 is a flow diagram showing a method for discovering a residential gateway according to an exemplary embodiment of the present invention;

FIG. 2 is a network diagram showing information flow between devices according to the exemplary method of FIG. 1;

FIG. 3 is a flow chart showing acts that are performed to practice the present invention, according to the exemplary method of FIG. 1; and

FIG. 4 is a block diagram showing a WAN bridge that has a processor that is configured to perform the acts of FIG. 3.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

The exemplary embodiment of the present invention described herein provides a way for a WAN bridge (which can be an ONT, a modem, or another device )to automatically determine which IP device of a LAN is the gateway and correspondingly restrict traffic flows to/from the LAN through the gateway. In this manner, features of the gateway, such as a firewall and/or parental controls, can be advantageously utilized.

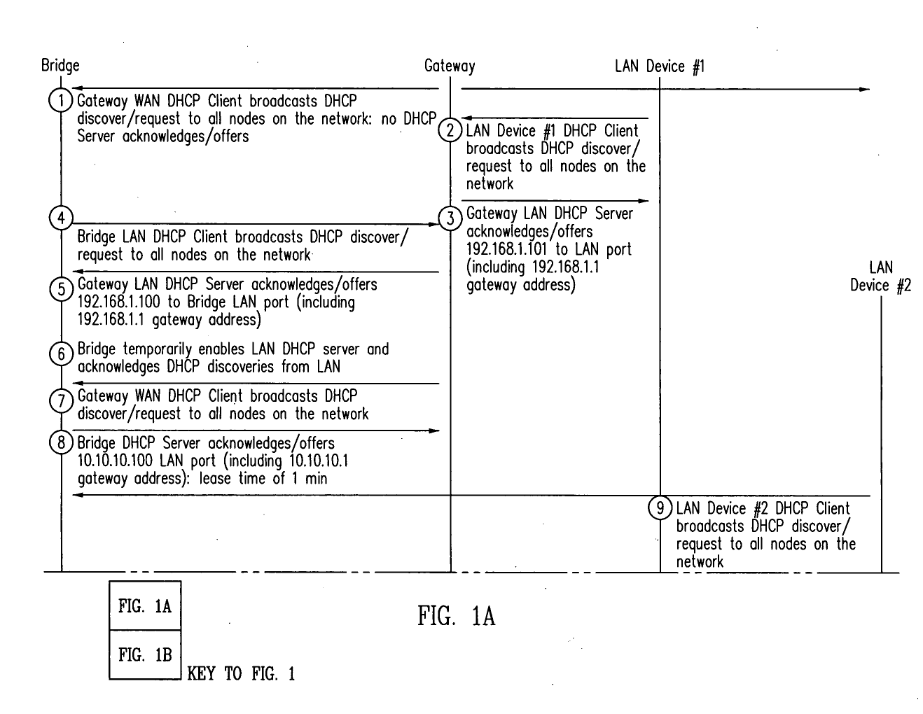

Referring now to FIG. 1-3, an embodiment of the present invention uses the standard DHCP protocol to implement a provisioning and setup flow between the WAN bridge and gateway so as to automate discovery of the gateway inside the home or business network. The WAN bridge can be an ONT or modem based on any last mile type (DOCSIS, ADSL, VDSL, etc). The shared medium used for the home or business network and WAN connection on the gateway can be wireless, MOCA, HomePlug, or other technology.

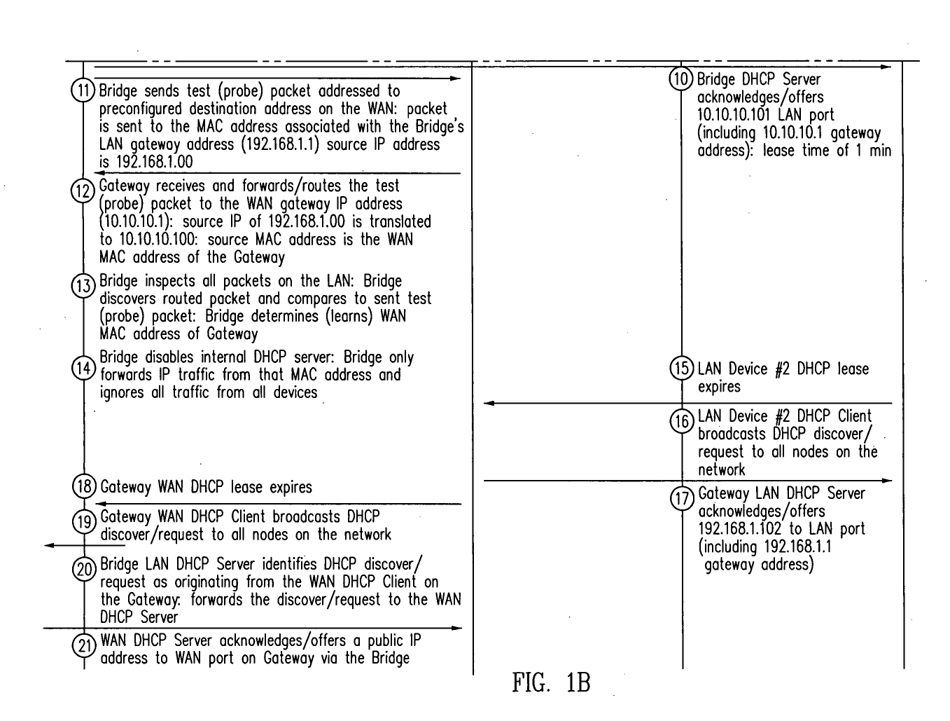

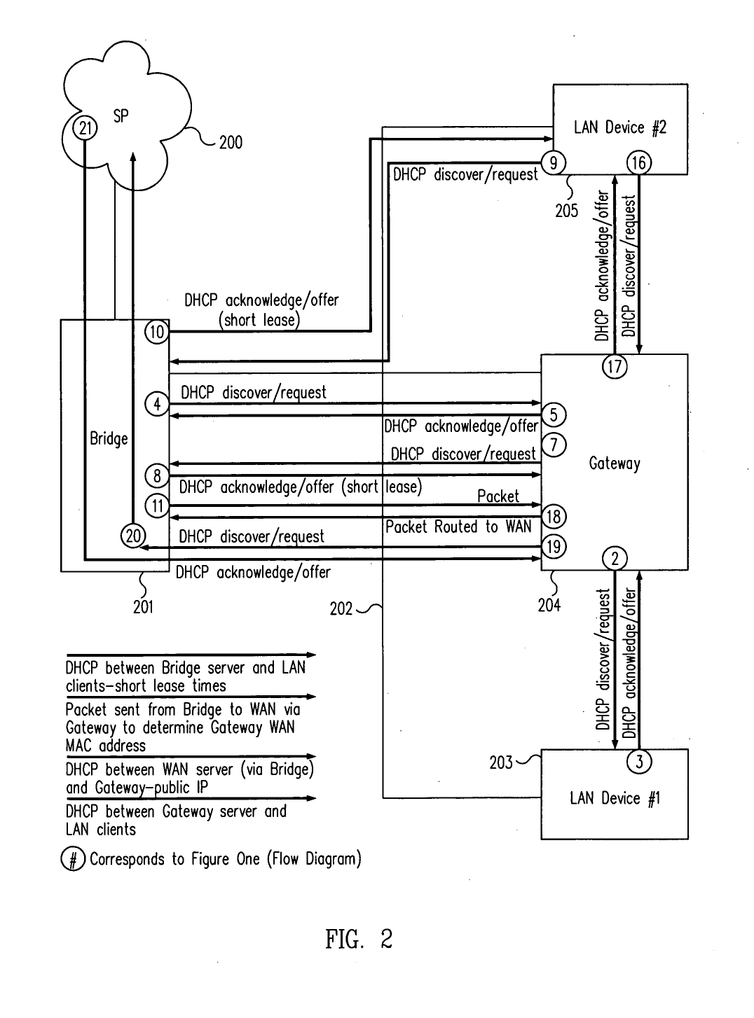

An assumption can be made that the gateway will recognize, but not respond to, a DHCP discover/request originating from itself. The WAN bridge can be installed by the service provider for broadband connectivity. Either the user or the service provided can install a gateway and IP clients on the shared physical medium (such as that of MOCA, HomePlug, WiFi wireless, etc.). Once installed, the bridge then sends out a DHCP discovery (on its LAN port) to identify any DHCP servers on the shared medium, as indicated by the circled number 4 of FIGS. 1 and 2, as well as by block 301 for FIG. 3.

The residential gateway (gateway) will be the only device to respond (it is assumed that the only DHCP server in the network is implemented within the gateway) and is thus identified by the bridge. The bridge obtains a private IP address from the gateway, as indicated by the circled number 5 of FIGS. 1 and 2, as well as by block 302 of FIG. 3.

Once the bridge identifies that there is a gateway downstream, it temporarily enables a LAN DHCP server and responds to any and all DHCP requests from devices on the LAN (clients, PCs, gateways, routers, etc.). The lease time on the IP addresses is set to a short value, e.g., 1 minute or less. At this point the gateway will obtain a short lease IP address and gateway address from the bridge, as indicated by the circled numbers 6-10 of FIGS. 1 and 2, as well as by block 303 of FIG. 3. It is worthwhile to note that by only enabling the DHCP server when the presence of a gateway has been discovered, the bridge will avoid disrupting a home or business network that does not have a gateway.

The bridge will then transmit test (probe) traffic from its LAN side to the gateway using a destination IP address anywhere in the public IP network, as indicated in block 304 of FIG. 3. The gateway will be the only device to forward this traffic from its LAN port to its WAN port. Since the gateway has obtained a short lease gateway address from the bridge, this traffic will be forwarded to that gateway address, as indicated by block 305 of FIG. 3. By analyzing the packet the bridge (e.g., as a learning bridge) will be able to learn the WAN MAC address of the gateway, as indicated by the circled numbers 11-13 of FIG. 1 and 2, as well as by block 306 of FIG. 3.

It is worthwhile to note that if the gateway has been provisioned with multiple WAN MAC addresses, it must forward the test (probe) traffic once for every MAC address assigned. This allows the bridge to learn and add to its forwarding table all WAN MAC addresses that must be forwarded. Furthermore, if the gateway has been provisioned with MAC addresses for LAN devices that must receive public IP addresses, e.g., CableHome, the gateway must also forward the test (probe) traffic once for every MAC address for each device that has been provisioned.

At this point, the bridge has identified the WAN MAC address of the gateway and the original DHCP leases offered by the bridge DHCP server will be expiring. However, if the bridge has not yet found the WAN MAC address of the gateway, it can renew the leases of the LAN device IP addresses and send the traffic again in an attempt to find it. The leases should not permanently expire until the WAN MAC address of the gateway is found.) Once the bridge has learned the gateway WAN MAC address, it will disable its own DHCP server to prevent renewing LAN DHCP requests. The bridge will then forward only those DHCP requests that originate from the gateway, i.e., the only device in the home or business network that should receive an IP address from a WAN side DHCP server is the identified gateway. Other IP client DHCP requests will be blocked (filtered) by the bridge and thus never seen by the service provider network, as indicated by the circled numbers 14 and 18-21.

Furthermore, the bridge will then only forward IP traffic sourced from the gateway in the upstream direction and will ignore traffic from other devices. In the downstream direction, traffic will only be forwarded directly to the gateway, as indicated by block 307 of FIG. 3.

Any short lease IP address assigned by the bridge's DHCP server to any LAN device will expire and subsequent DHCP addresses for these and any other client devices will be from the gateway only. All traffic sourced by home or business networking device will be directed only to the gateway, as indicated by the circled numbers 15-17.

The bridge can retain the DHCP IP address assigned by the gateway in order to allow for LAN based management of the bridge via the gateway. This would be important for self install, self diagnostics, service enablement, etc.

With particular reference to FIG. 2, a service provider 200 provides a broadband connection to a bridge 201. As mentioned above, bridge 201 may be an ONT or modem based on any last mile type, such as DOCSIS, ADSL, VDSL, etc. Bridge 201 communicates with a LAN (such as a home or business network) defined, at least partially, by first LAN device 203, second LAN device 205, and gateway 204. First LAN device 203, second LAN device 205, and gateway 204 share a physical medium 202, which facilitates communication therebetween. Bridge 201 is capable of facilitating communication with first 203 and second 205 LAN devices via gateway 204. It is also capable of facilitating communication with first 203 and second 205 LAN devices without routing the communication through gateway 204.

It is worthwhile to note that the IP addresses shown in FIG. 1 are defined for this example only and are not necessarily the IP addresses that will result from practice of the present invention. Thus, these IP addresses are by way of illustration and not by way of limitation.

DHCP requests from downstream are used to discover a gateway and to obtain a private IP address from the gateway. Subsequently, the traffic sent downstream is then used to find the correct logical connection with the gateway. According to contemporary practice, all DHCP requests are typically made upstream and bridges do not implement DHCP at all (they just pass through traffic).

An alternative network configuration is to locate the DHCP server responding with short term lease DHCP addresses upstream from the bridge. Strictly speaking, the DHCP server that responds with the short term lease would not have to be integrated into the bridge. However, there are practical network maintenance and support issues to consider if that DHCP server is located upstream of the bridge. For example, the physical location of the DHCP server can be critical. It should be physically located in such a way as to ensure that devices on the home or business network are guaranteed to see an offer from the server in question before it sees offers from other DHCP servers on the network.

Alternative applications for the present invention include: use in deployments where an gateway is configured to administer one and only one private IP address via DHCP (as described in TR-068 I-202 “single PC mode”) wherein more than one LAN device can request an IP address via DHCP, in which case there is no guarantee that the single available DHCP address would be assigned to the correct LAN device; and use in deployments where a DSL modem is configured to share its public WAN IP address obtained by PPPOE with a single LAN device (as described in TR-068 I-197 “IP passthrough”) wherein more than one LAN device could compete with a router for that IP address via DHCP.

According to one or more embodiments of the present invention, there can be other implementations in which the bridge learns which DHCP traffic to forward. For example, the gateway or a LAN device can require a public IP address. If the LAN device has been configured to include DHCP Option 60, the bridge should add the WAN MAC address associated to that DHCP request to its forwarding table. However, these other methods require changes to be made on the LAN devices.

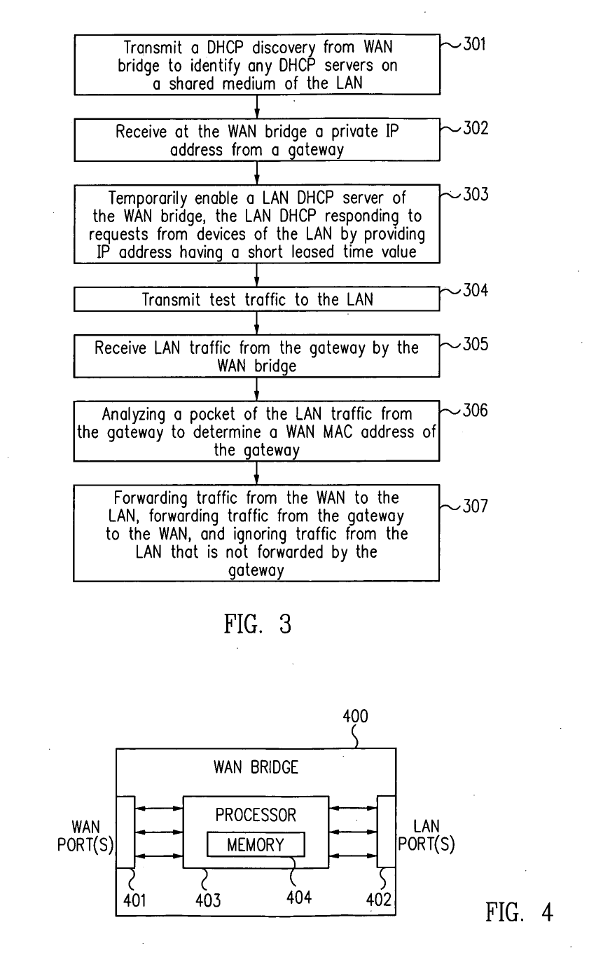

Referring now to FIG. 4, a WAN bridge 400 can be configured to perform at least some of the steps of FIG. 3 by using a processor 403. Processor 403 can be either a general purpose computer or custom processor that is specifically configured to practice the present invention.

Processor 403 comprises and/or communicates with a memory 404. Memory 404 can be disposed within WAN bridge 400. Alternatively, memory 404 can be disposed elsewhere. Instructions for performing the acts of FIG. 3 can be stored in memory 404. Memory 404 can also be used to store values that are obtained or generated during the practice of the present invention. For example, memory 404 can be used to store IP addresses that are used when WAN bridge 400 functions as a LAN DHCP server.

As used herein, the term “gateway” can refer to a residential gateway. The term gateway can refer to any device, including a general purpose computer, that performs at least some of the functions associated with a contemporary gateway. Thus, gateway 400 does not have to be limited to the functions commonly associated with a contemporary gateway and gateway 400 does not have to be a dedicated gateway.

According to this exemplary embodiment of the present invention, a WAN bridge is used to discover one or more gateways of the LAN and to control traffic flow between the WAN and the LAN. However, such discovery and control may be performed by another device or combination of devices. Thus, discussion herein regard a WAN bridge is by way of illustration and not by way of limitation.

The exemplary embodiment of the present invention described herein provides a way for a WAN bridge or other device(s) to discover a gateway and then restrict communication between the WAN and LAN through the gateway. In this manner, features of the gateway, such as a firewall and/or parental controls, can be advantageously utilized. This is accomplished in a manner that does not conflict with existing gateways and routers or require technologies that typically do not reside in consumer based products.

Embodiments described above illustrate, but do not limit, the invention. It should also be understood that numerous modifications and variations are possible in accordance with the principles of the present invention. Accordingly, the scope of the invention is defined only by the following claims.

1. A method for facilitating communication between a LAN and a WAN, the method comprising determining which IP device of the LAN is a gateway and then restricting communication between the LAN and the WAN such that the communication is routed through the gateway.

2. The method as recited in claim 1, wherein determining which IP device of the LAN is a gateway is performed by a WAN bridge.

3. The method as recited in claim 1, wherein restricting communication between the LAN and the WAN is performed by a WAN bridge.

4. The method as recited in claim 1, wherein determining which IP device of the LAN is a gateway comprises using DHCP protocol to implement a provisioning and to setup flow between a WAN bridge and the gateway.

5. The method as recited in claim 1, wherein determining which IP device of the LAN is a gateway comprises identifying a DHCP server on a shared medium of the LAN.

6. The method as recited in claim 1, wherein determining which IP device of the LAN is a gateway comprises transmitting a DHCP discovery.

7. The method as recited in claim 1, wherein determining which IP device of the LAN is a gateway comprises obtaining a private IP address from the gateway.

8. The method as recited in claim 1, wherein determining which IP device of the LAN is a gateway comprises temporarily enabling a LAN DHCP server and responding to DHCP requests from devices on the LAN.

9. The method as recited in claim 1, wherein determining which IP device of the. LAN is a gateway comprises:
temporarily enabling a LAN DHCP server; and
responding to DHCP requests from devices on the LAN;
wherein a lease on time for the IP address is set to less than approximately one minute.

10. The method as recited in claim 1, wherein determining which IP device of the LAN is a gateway comprises providing a short lease IP address to a gateway.

11. The method as recited in claim 1, wherein determining which IP device of the LAN is a gateway comprises enabling a DHCP server only after the presence of a gateway has been discovered.

12. The method as recited in claim 1, wherein determining which IP device of the LAN is a gateway comprises transmit testing traffic from within the LAN to a gateway using a destination IP address anywhere in the public IP network and analyzing a packet from the gateway to determine a MAC address of the gateway.

13. The method as recited in claim 1, wherein restricting communication between the LAN and the WAN comprises:
forwarding IP traffic from a gateway to the WAN;
ignoring IP traffic from the LAN that is not from the gateway; and
forwarding IP traffic from the WAN to the gateway.

14. A method for using a WAN bridge to facilitate communication between a LAN and a WAN, the method comprising:
transmitting a DHCP discovery from the WAN bridge to identify any DHCP servers on a shared medium of the LAN;
receiving at the WAN bridge a private IP address from a gateway;
temporarily enabling a LAN DHCP server of the WAN bridge, the LAN DHCP server responding to requests from devices of the LAN by providing IP addresses having a short leased time value;
transmit testing traffic from the LAN, the transmit testing being performed by the bridge;
receiving LAN traffic from the gateway by the WAN bridge;
analyzing a packet of the LAN traffic from the gateway to determine a MAC address of the gateway;
forwarding traffic from the WAN to the LAN by the WAN bridge;
forwarding traffic from the gateway to the WAN by the WAN bridge; and
ignoring traffic from the LAN that is not forwarded by the gateway.

15. The method as recited in claim 14, wherein the short leased time value is less than approximately one minute.

16. A bridge comprising a processor that is configured to determine which IP device of the LAN is a gateway and then restrict communication between the LAN and the WAN such that the communication is routed through the gateway.

17. The bridge as recited in claim 16, wherein the processor is configured to use DHCP protocol to implement a provisioning and setup flow between a WAN bridge and gateway.

18. The bridge as recited in claim 16, wherein the processor is configured to identify a DHCP server on a shared medium of the LAN.

19. The bridge as recited in claim 16, wherein the processor is configured to transmit a DHCP discovery.

20. The bridge as recited in claim 16 wherein the processor is configured to obtain a private IP address from the gateway.

21. The bridge as recited in claim 16, wherein the processor is configured to temporarily enable a LAN DHCP server and responding to DHCP requests from devices on the LAN.

22. The bridge as recited in claim 16, wherein the processor is configured to:
temporarily enable a LAN DHCP server;
respond to DHCP requests from devices on the LAN; and
wherein a lease on time for the IP address is set to less than approximately one minute.

23. The bridge as recited in claim 16, wherein the processor is configured to provide a short lease IP address to a gateway.

24. The bridge as recited in claim 16, wherein the processor is configured to only enabling a DHCP server after the presence of a gateway has been discovered.

25. The bridge as recited in claim 16 wherein the processor is configured to transmit test traffic within the LAN to a gateway using a destination IP address anywhere in the public IP network and to analyze a packet from the gateway to determine a MAC address of the gateway.

26. The bridge as recited in claim 16, wherein the processor is further configured to:
forward IP traffic from a gateway to the WAN;
ignore IP traffic from the LAN that is not from the gateway; and
forward IP traffic from the WAN to the gateway.

27. A bridge comprising a processor, the processor being configured to:
transmit a DHCP discovery from the WAN bridge to identify any DHCP servers on a shared medium of the LAN;
receive at the WAN bridge a private IP address from a gateway;
temporarily enable a LAN DHCP server of the WAN bridge, the LAN DHCP responding to requests from devices of the LAN by providing IP addresses having a short time value;
transmit test traffic from the LAN, the transmit testing being performed by the bridge;
receive LAN traffic from the gateway by the WAN bridge;
analyze a packet of the LAN traffic from the gateway to determine a MAC address of the WAN bridge;
forward traffic from the WAN to the LAN by the WAN bridge;
forward traffic from the gateway to the WAN by the WAN bridge; and
ignore traffic from the LAN that is not forwarded by the gateway.

28. The bridge as recited in claim 27, wherein the short time value is less than approximately one minute.

29. A bridge comprising:
a WAN port;
a LAN port;
a processor, the processor comprising:
means for transmitting a DHCP discovery from the WAN bridge to identify any DHCP servers on a shared medium of the LAN;
means for receiving at the a private IP address from a gateway;
means for temporarily enable a LAN DHCP server of the WAN bridge, the LAN DHCP responding to requests from devices of the LAN by providing IP addresses having a short time value;
means for transmitting test traffic from the LAN, the transmit testing being performed by the bridge;
means for receiving LAN traffic from the gateway by the WAN bridge;
means for analyzing a packet of the LAN traffic from the gateway to determine a MAC address of the WAN bridge;
means for forwarding traffic from the WAN to the LAN by the WAN bridge;
means for forwarding traffic from the gateway to the WAN by the WAN bridge; and
means for ignoring traffic from the LAN that is not forwarded by the gateway.
